(19) United States
(12) Patent Application Publication
(10) Pub. No.: US 2010/0090147 A1
(43) Pub. Date: Apr. 15, 2010

(54) Vehicle air system valve control with learned motion limits

(76) Inventors: Mario A. Recio, Chihuahua (MX); Esau Aguinaga, Chihuahua (MX); Yingjie Lin, El Paso, TX (US)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/287,555

(22) Filed: Oct. 10, 2008

(51) Int. Cl. F16K 31/04; F02D 41/00

(52) U.S. Cl. 251/249.5; 701/102

(57) ABSTRACT

A valve actuator includes a motor coupled to an output shaft that in turn can be coupled to valve elements in a vehicle air passage to move the elements. A position sensing component is provided to produce feedback of actuator motion, and limits of actuator travel for any particular application can be learned in a learning mode and subsequently used in an operating mode to satisfy commands of an engine control module (ECM).

### I. FIELD OF THE INVENTION

The present invention relates generally to vehicle air system valve control with learned limits of motion.

### II. BACKGROUND OF THE INVENTION

Various vehicle air systems require valves for various reasons. As one example, a vacuum valve actuator can be disposed in an intake manifold to improve cold start performance and to vary the length of air passages to provide for better tuning. However, not only do present actuators tend to suffer mechanical issues when, for instance, they are cold, they can also become misadjusted without providing feedback of the condition. Further, because different applications in the same engine may demand different limits of mechanical motion, more than one type of valve assembly typically must be provided, which increases manufacturing and inventory costs.

### SUMMARY OF THE INVENTION

A valve actuator has a motor and an output shaft coupled to the motor. The output shaft can be coupled to one or more valve elements in a vehicle air passage to move the elements. A position sensing component is configured to produce feedback of actuator motion. Limits of actuator travel for an application are learned in a learning mode and subsequently used in an operating mode to satisfy commands of an engine control module (ECM).

In example embodiments the motor is a DC motor coupled to the output shaft by a worm gear and a helical gear. The position sensing component can include a sensing element, and a magnet may be disposed to rotate with the output shaft. The sensing element can be a non-contact sensing element sensing the angular position of the magnet.

The learning mode may be entered upon the occurrence of a predefined condition. In any case, in examples of the learning mode, the motor rotates the output shaft in a commanded direction until a first limit of actuator travel is sensed. A position associated with the first limit of travel is sensed by the position sensing component and recorded. The motor also rotates the output shaft in a commanded direction until a second limit of actuator travel is sensed, with a position associated with the second limit of travel being sensed by the position sensing component and recorded. The positions associated with the first and second limits of travel are used to operate the actuator. If desired, periodically the actuator can attempt to drive the motor past the limits of motion to determine whether any linkages may be broken or decoupled.

In another aspect, an actuator includes a DC motor, a worm gear rotated by the DC motor, a helical gear meshed with the worm gear, and an output shaft coaxially disposed with the helical gear and coupled thereto to turn therewith. A permanent magnet rotates with the output shaft and a non-contact position sensor is disposed to sense the angular position of the magnet. A microcontroller receives the output signal of the position sensor.

In another aspect, a method includes engaging an actuator with a vehicle, coupling the actuator to at least one valve element in the vehicle, and operating the actuator until the valve element reaches a mechanical stop. The method also includes sensing within the actuator a position representing a limit of travel associated with the mechanical stop, recording the position, and subsequently using the position to respond to at least one command from an engine control module.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a top plan view of one example application of the present valve actuator controlling two valves in an air intake manifold of a vehicle engine, with portions of the manifold removed for clarity;

FIGS. 2 and 3 are top plan views of the air intake manifold respectively showing the valves in the open and closed positions;

FIG. 4 is a perspective view of an example embodiment of the valve actuator;

FIG. 5 is a side view of the interior of the example actuator effectively in partial cross-section but without showing cross-hatching;

FIG. 6 is a perspective view of some of the internal components of the example valve actuator;

FIG. 7 is a block diagram of the example valve actuator; and

FIG. 8 is a flow chart showing example modes of operation.

### DETAILED DESCRIPTION OF THE PREFERRED EMBODIMENT

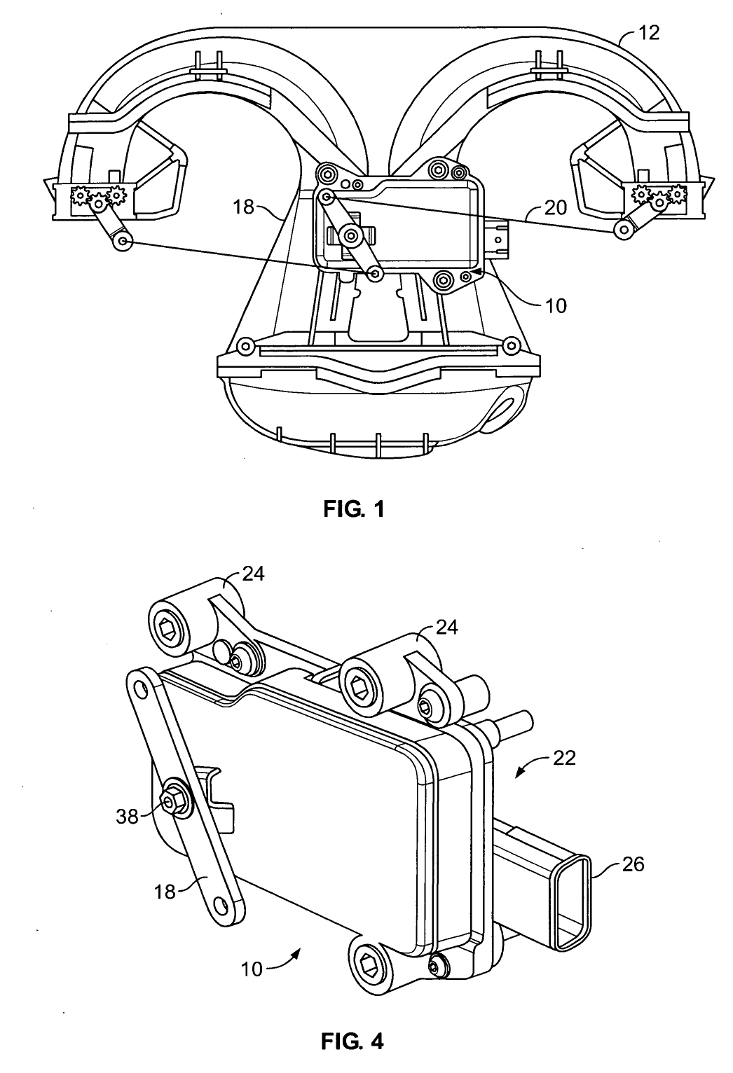

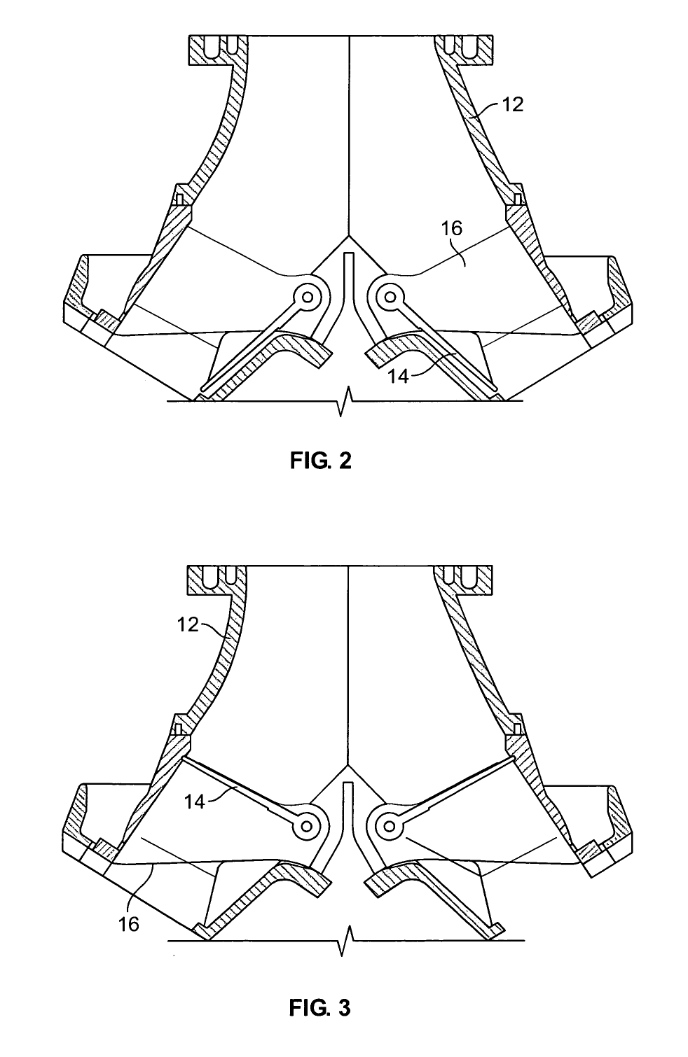

Referring initially to FIG. 1, a valve actuator 10 may be mounted on an engine that can include an air intake manifold 12 having one or more air passageway valves 14 (FIGS. 2 and 3) disposed in respective air passageways 16. The valves 14 can move between an open position (FIG. 2), in which the respective air passageway 16 is substantially not blocked, and a closed position (FIG. 3), in which the respective air passageway 16 is at least partially blocked. As can be appreciated in cross-reference to FIGS. 1-3, opposed ends of a rotatable actuator arm 18 of the actuator 10 are coupled to the valves 14 by appropriate linkages 20 to move the valves 14 between the open and closed positions shown in FIGS. 2 and 3. However, while FIGS. 1-3 illustrate present principles in the context of an air intake manifold, it is to be understood that the actuator 10 may be used in other applications without modifying the mechanical components discussed below. For instance, the actuator 10 may be used in other locations of the manifold 12 as well as in one or more locations in an associated fuel cell engine. As well, because the limits of mechanical travel of the actuator arm 18 are learned, the actuator 10 may be mounted for the same application in more than one orientation. Furthermore, by learning the limits of mechanical travel for the particular application and location, deviations from manufacturing tolerances can be compensated for.

FIG. 4 shows a hollow actuator housing 22 with one or more mounting brackets 24 formed integrally thereon. The housing 22 holds the below-described components of the actuator 10. The actuator arm 18 may be rotatably mounted relative to the housing 22 as shown. The housing 22 may also be formed with an electrical socket 26 that can be engaged with a power and signal cord to receive power from, e.g., the battery of the vehicle as well as to communicate data with the vehicle's engine control module (ECM).

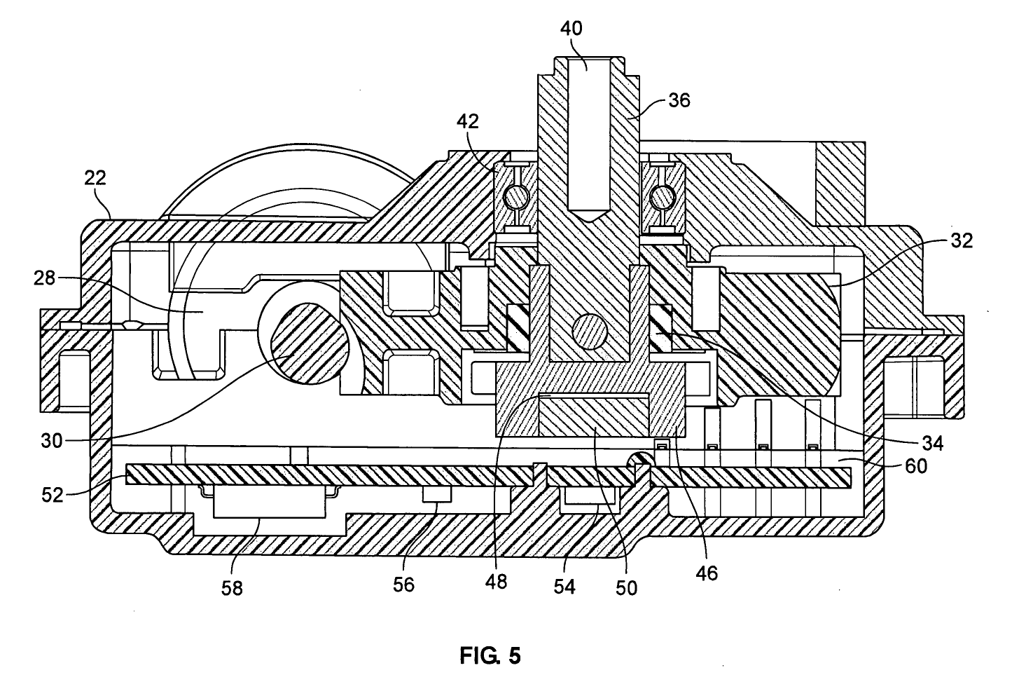

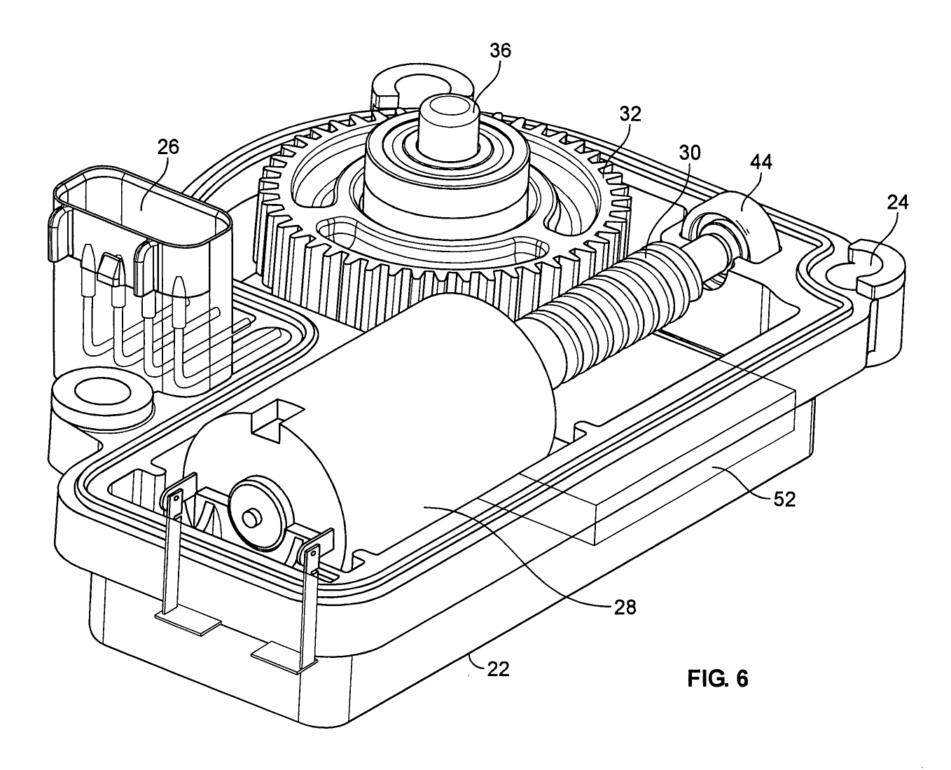

FIGS. 5 and 6 show some of the components that can be contained in the actuator housing 22, which may be made of plastic. A preferably direct current (DC) motor 28 may drive a worm gear 30 that meshes with one or more helical gears 32 that can be made of plastic. A rubber coupler 34 may be positioned coaxially within the helical gear 32 as shown to transmit rotational force to an output shaft assembly including an output shaft 36 that may be, e.g., stainless steel. It is to be understood that the output shaft 36 is connected to the midpoint of the actuator arm 18 shown in FIG. 4 by, for example, a bolt 38 (FIG. 4) that passes through the arm 18 and engages a central bore 40 of the output shaft 36. The shaft 36 may be radially supported by a ball bearing assembly 42 in the housing as shown while the end of the worm gear 30 that is distanced from the motor 28 may be supported by a journal bearing 44 (FIG. 6). With this combination of structure, it will be appreciated that the shaft of the motor 28 may be rotated clockwise to rotate the output shaft 36 (and, hence, actuator arm 18) in one direction, and may also be rotated counterclockwise to rotate the output shaft 36 (and, hence, actuator arm 18) in the opposite direction.

As shown best in FIG. 5, the shaft assembly not only includes the output shaft 36 but also a magnet holder 46 that is coaxially engaged with the output shaft 36 and the helical gear 32 to rotate therewith. The magnet holder 46 is formed with a central lower cavity 48 that is configured to securely hold a permanent magnet 50, such that the magnet 50 turns with the output shaft 36.

A printed circuit board (PCB) 52 may be disposed in the housing 22 and may hold a non-contact sensing element 54 directly below (i.e., along the axis of rotation) the magnet 50. In one non-limiting embodiment the sensing element 54 may include a Hall effect sensor and may be established by chip model MLX90316 made by Melexis of Concord, NH. The sensing element 54 outputs a signal representative of the angular position of the magnet 50.

As also shown in FIG. 5, the PCB 52 may also bear a microcontroller 56 and an H-bridge 58. As the skilled artisan will recognize, the H-bridge facilitates driving the motor 28 in both clockwise and counterclockwise directions. The PCB 52 may be partially or completely encased in protective epoxy 60.

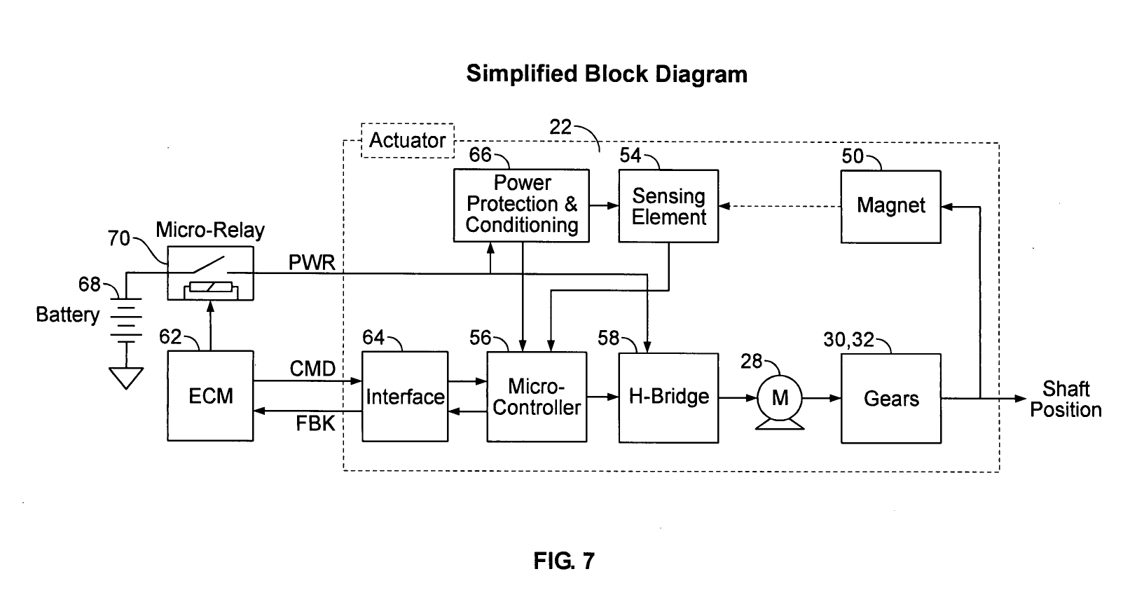

FIG. 7 shows a block diagram of the electrical components discussed above. A vehicle engine control module (ECM) 62 may communicate with the microcontroller 56 through an appropriate communication interface 64 in the housing 22. The microcontroller 56 cooperates with the H-bridge 58 to establish a desired rotation of the motor 28 to fulfill commands from the ECM 62 received on a command line “CMD”.

The angular position of the magnet 50 (and, hence, of the output shaft 28) is sensed by the sensing element 54. Power protection and conditioning circuitry 66 may be associated with the sensing element 54 as shown, and may be included on the same chip on which the sensing element 54 is vended. The output of the sensing element 54, representing the angular position of the output shaft 28, is sent to the microcontroller 56, which in turn sends the information to the ECM 62 on a feedback line “FBK”. If desired, power may be supplied on a power line “PWR” by the vehicle battery 68 or other source (e.g., the vehicle's alternator) through a power relay 70 to the circuitry 66, microcontroller 56, and H-bridge 58 as shown in FIG. 7.

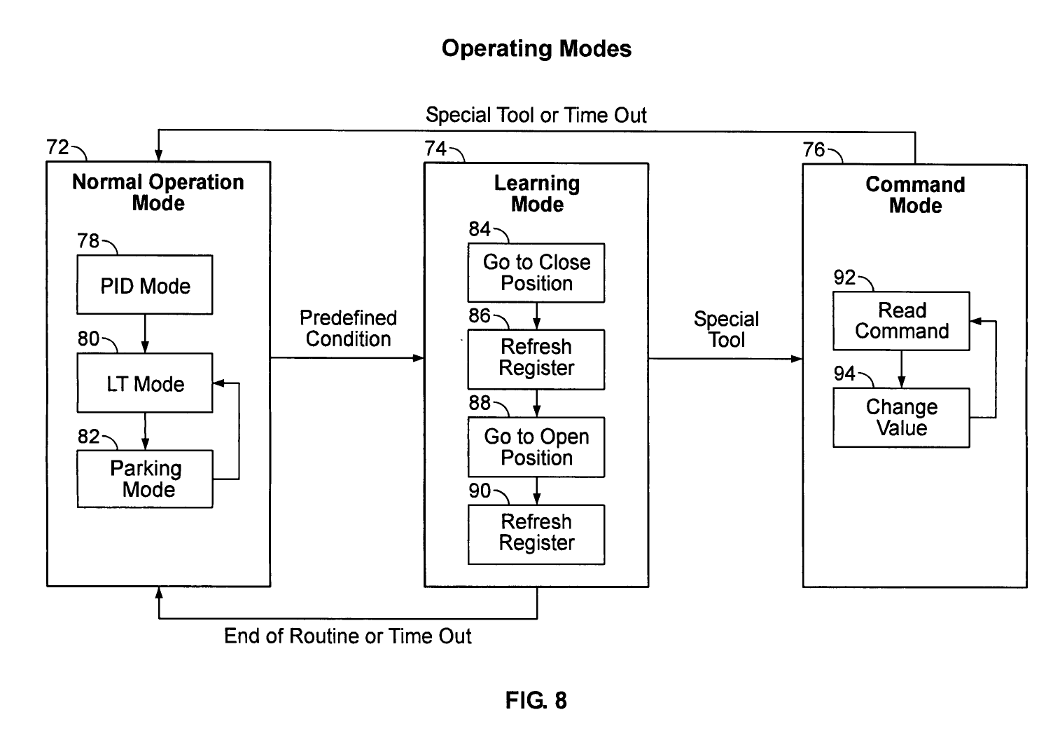

FIG. 8 shows that the example non-limiting microcontroller 56 has three modes, namely, a normal operating mode 72, a learning mode 74, and a command mode 76. Within the normal operating mode 72, the microcontroller can assume a proportional integral derivative (PID) mode 78 in which a PID algorithm is executed based on pre-loaded parameters including motion parameters and end of travel parameters (discussed further below) for fast and accurate positioning of the output shaft 28 in response to commands from the ECM. Periodically in the normal operating mode 72, the microcontroller may enter a linkage test mode 80 in which it is attempted to drive the motor past the limits of motion that have been “learned” as outlined further below, to determine whether any linkages may be broken or decoupled. If so, the ECM is notified to permit presenting an alarm on a vehicle output device and/or to record a fault that later can be revealed during diagnostics.

A parking mode 82 may also be entered to power down some of the components of the actuator to save energy when no movement is required. The parking mode 82 is left and the PID mode resumes when it signals from the ECM and sensing element indicate that the output shaft is not in the commanded position.

The microcontroller can also assume a learning mode 74 upon a predefined condition such as, e.g., connecting a jumper between the feedback line and command line. In the learning mode, the microcontroller causes the motor to rotate the output shaft in a commanded direction (e.g., the “close direction at 84) until a mechanical stop (end of travel) is sensed by, e.g., rapidly increasing motor current. For example, the motor may be caused to rotate until the valve elements 14 shown in FIGS. 2 and 3 reach their fully closed positions and thus prevent further motion in that direction. The end of travel position as indicated by the signal from the sensing element 54 is recorded in a register at step 86, then the motor is rotated in the opposite direction at step 88 to find and record the other end of travel position at step 90. When the predefined condition is removed or at the elapse of a time out period, the normal operating mode 72 is resumed.

The microcontroller may also enter the command mode 76 when, for instance, an external programming tool is engaged with, e.g., the command line and thus with the microcontroller. In the command mode, parameters that define operation in the PID mode 78 are read at state 92 and adjusted as necessary at state 94. These parameters may include, by way of non-limiting example, time values, rotational distances for operation and diagnostics (e.g., the distances beyond end of travel to use in the LT mode 80), maximum response time, allowed over-travel, motion control parameters, and gear backlash.

While the particular VEHICLE AIR SYSTEM VALVE CONTROL WITH LEARNED MOTION LIMITS is herein shown and described in detail, it is to be understood that the subject matter which is encompassed by the present invention is limited only by the claims.

What is claimed is:

1. A valve actuator comprising:
a motor;
an output shaft coupled to the motor, the output shaft being couplable to at least one valve element in a vehicle air passage to move the element; and
a position sensing component configured to produce feedback of actuator motion, wherein limits of actuator travel for an application are learned in a learning mode and subsequently used in an operating mode to satisfy commands of an engine control module (ECM).

2. The actuator of claim 1, wherein the motor is a DC motor coupled to the output shaft at least in part by a worm gear.

3. The actuator of claim 2, wherein the motor is a DC motor coupled to the output shaft at least in part by a helical gear.

4. The actuator of claim 1, wherein the position sensing component includes a sensing element, and a magnet is disposed to rotate with the output shaft, the sensing element being a non-contact sensing element sensing the angular position of the magnet.

5. The actuator of claim 1, wherein the learning mode is entered upon the occurrence of a predefined condition.

6. The actuator of claim 1, wherein in the learning mode, the motor rotates the output shaft in a commanded direction until a first limit of actuator travel is sensed, a position associated with the first limit of travel being sensed by the position sensing component and recorded, the motor also rotating the output shaft in a commanded direction until a second limit of actuator travel is sensed, a position associated with the second limit of travel being sensed by the position sensing component and recorded, the positions associated with the first and second limits of travel being used to operate the actuator.

7. The actuator of claim 6, wherein the actuator attempts to drive the motor past the limits of motion to determine whether any linkages may be broken or decoupled.

8. An actuator comprising:
a DC motor;
a worm gear rotated by the DC motor;
a helical gear meshed with the worm gear;
an output shaft coaxially disposed with the helical gear and coupled thereto to turn therewith;
a permanent magnet rotating with the output shaft;
a non-contact position sensor disposed to sense the angular position of the magnet; and
a microcontroller receiving an output signal of the position sensor.

9. The actuator of claim 8, comprising an actuator arm coupled to the output shaft and couplable to at least one valve element in a vehicle air passage to move the element.

10. The actuator of claim 8, wherein the microcontroller uses the output signal to learn limits of actuator travel for use thereof to satisfy commands of an engine control module (ECM).

11. The actuator of claim 8, wherein the position sensor includes a Hall effect sensor.

12. The actuator of claim 8, wherein a learning mode is entered upon the occurrence of a predefined condition to learn the limits of actuator travel.

13. The actuator of claim 8, wherein in a learning mode, the motor rotates the output shaft in a commanded direction until a first limit of actuator travel is sensed, a position associated with the first limit of travel being sensed by the position sensor and recorded, the motor also rotating the output shaft in a commanded direction until a second limit of actuator travel is sensed, a position associated with the second limit of travel being sensed by the position sensor and recorded, the positions associated with the first and second limits of travel being used to operate the actuator.

14. The actuator of claim 6, wherein the microcontroller attempts to drive the motor past the limits of motion to determine whether any linkages may be broken or decoupled.

15. Method comprising:
engaging an actuator with a vehicle;
coupling the actuator to at least one valve element in the vehicle;
operating the actuator until the valve element reaches a mechanical stop;
sensing within the actuator a position representing a limit of travel associated with the mechanical stop;
recording the position; and
subsequently using the position to respond to at least one command from an engine control module.

16. The method of claim 15, wherein the mechanical stop is first mechanical stop and the method further comprises:
operating the actuator until the valve element reaches a second mechanical stop;
sensing within the actuator a position representing a limit of travel associated with the second mechanical stop;
recording the position representing a limit of travel associated with the second mechanical stop; and
subsequently using the positions to respond to at least one command from an engine control module.

17. The method of claim 16, comprising:
attempting to move the actuator past the limits of motion to determine whether any linkages may be broken or decoupled.

18. The method of claim 15, comprising entering a command mode in which parameters that define operation of the actuator are read and adjusted as necessary.

19. The method of claim 18, wherein the parameters include time values, rotational distances.
